(19) United States
(12) Patent Application Publication
(10) Pub. No.: US 2026/0283104 A1
(43) Pub. Date: Sep. 24, 2026

(54) KENNEL

(71) Applicant: DOSKOCIL MANUFACTURING COMPANY, INC., Arlington, TX (US)

(72) Inventors: Paul Tsu Peng King, Southlake, TX (US); Michael Harper, Fort Worth, TX (US); Ryan Paxson, Elk Rapids, MI (US)

(73) Assignee: DOSKOCIL MANUFACTURING COMPANY, INC., Arlington, TX (US)

(21) Appl. No.: 19/575,855

(22) Filed: Mar. 23, 2026

Related U.S. Application Data
(60) Provisional application No. 63/776,877, filed on Mar. 24, 2025.

(51) Int. Cl. A01K 1/03; A01K 1/02

(52) U.S. Cl. CPC A01K 1/034; A01K 1/0245

(57) ABSTRACT

A kennel includes a base, a plurality of connection pieces, a lid, and a plurality of side panels. Each of the connection pieces includes a lower end coupled to the base and an upper end. The lid includes a plurality of side panel receiving fasteners each configured to move between a locked position and an unlocked position. The upper end of each of the connection pieces is coupled to the lid. Each of the side panels is coupled to the lid when a corresponding one of the side panel fasteners is in the locked position. The lid includes a plurality of apertures and the connection pieces each include a plurality of connection piece channels. In the unlocked position the side panel fastener is configured to permit the corresponding side panel to be received within at least one of the connection piece channels via one or the apertures.

### CROSS-REFERENCE TO RELATED PATENT APPLICATION

This application claims benefit of and priority to U.S. Provisional Patent Application 63/776,877, filed on Mar. 24, 2025, which is hereby incorporated herein by reference in its entirety and for all purposes.

### TECHNICAL FIELD

The present disclosure relates generally to the field of pet care and animal housing, and more particularly to a kennel for housing a pet.

### BACKGROUND

Kennels are essential tools for pet owners to provide a secure and controlled environment for pets. The structures are used to confine pets for various reasons, including training and travel.

### SUMMARY

In one embodiment, a kennel includes a base, a plurality of connection pieces, a lid, and a plurality of side panels. Each of the connection pieces includes a lower end coupled to the base and an upper end spaced from the lower end. The lid includes a plurality of side panel receiving fasteners. Each of the side panel receiving fasteners is configured to move between a locked position and an unlocked position. The upper end of each of the connection pieces is coupled to the lid. Each of the side panels is coupled to the lid when a corresponding one of the side panel fasteners is in the locked position. The lid includes a plurality of apertures and the connection pieces each include a plurality of connection piece channels. In the unlocked position the side panel fastener is configured to permit the corresponding side panel to be received within at least one of the connection piece channels via one or the apertures.

In another embodiment, a kennel for an animal includes a base, a plurality of connection pieces selectively coupled to the base, a lid offset from the base, and a plurality of side panels configured to couple to the base, the lid, and two of the connection pieces. The lid includes a body portion and a plurality of side panel fasteners coupled to the body portion. Each of the side panel fasteners is configured to move between a locked position and an unlocked position. The body portion includes a plurality of apertures. Each of the connection pieces includes a plurality of channels. Each of the side panels is configured to slide through a corresponding one of the apertures in the lid to be captured within a channel of a corresponding first connection piece and a channel of a corresponding second connection piece. In the locked position at least a portion of one of the side panel fasteners is located within the corresponding aperture and the side panel fastener is configured to prevent a corresponding one of the side panels from being removed from the corresponding aperture. In the unlocked position the side panel fastener is configured to permit the corresponding side panel to be removed from the corresponding aperture.

In another embodiment, a kennel includes a base, a plurality of stepped inserts, a plurality of connection pieces, a lid, and a plurality of side panels. The stepped inserts are received within the base. Each of the connection pieces extends between a lower end and an upper end. The lower end is coupled to the base. One of the stepped inserts is received within the lower end. One of the stepped inserts is received within the upper end. The upper end of each of the connection pieces is coupled to the lid. One or more of the stepped inserts is received within the lid. Each of the side panels is coupled to the lid. The lid includes a plurality of apertures and the connection pieces each include a plurality of connection piece channels. The side panel is configured to be received within at least one of the connection piece channels via one of the apertures.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a perspective view of a kennel, including a lid and a base, in an example embodiment;

FIG. 2 is a top view of the kennel of FIG. 1, in an example embodiment;

FIG. 3 is a side view of the kennel of FIG. 1, in an example embodiment;

FIG. 4 is a rear view of the kennel of FIG. 1, in an example embodiment;

FIG. 5 is a front view of the kennel of FIG. 1, in an example embodiment;

FIG. 6 is a bottom view of the kennel of FIG. 1, in an example embodiment;

FIG. 7 is a perspective view of the base of the kennel of FIG. 1, in an example embodiment;

FIG. 8 is a perspective view of the lid of the kennel of FIG. 1, in an example embodiment;

FIG. 9 is detailed view of DETAIL A in FIG. 1, in an example embodiment;

FIG. 10 is detailed view of DETAIL B in FIG. 1, in an example embodiment;

FIG. 11 is a detailed view of DETAIL C in FIG. 2, including a fastener, in an example embodiment;

FIG. 12 is a perspective view of the fastener of FIG. 11, in an example embodiment;

FIG. 13 is a perspective view of the kennel of FIG. 1 taken along plane A-A in FIG. 1, including a plurality of corner stepped inserts and a plurality of intermediate stepped inserts, in an example embodiment;

FIG. 14 is a perspective view of the kennel of FIG. 1 taken along plane B-B in FIG. 1, in an example embodiment;

FIG. 15 is a perspective view of one of the corner stepped inserts of FIG. 13, in an example embodiment;

FIG. 16 is a perspective view of one of the intermediate stepped inserts of FIG. 13, in an example embodiment;

FIG. 17 is a perspective view of the kennel of FIG. 1 in a play pen configuration, in an example embodiment;

FIG. 18 is a perspective view of the kennel of FIG. 1 in a den configuration, in an example embodiment;

FIG. 19 is a perspective view of the kennel of FIG. 1 in a crate configuration, in an example embodiment;

FIG. 20 is a perspective view of the kennel of FIG. 1 in a storage or shipping configuration, in an example embodiment;

FIG. 21 is a perspective view of the kennel of FIG. 1, in an example embodiment;

FIG. 22 is a side view of the kennel of FIG. 21, in an example embodiment; and

FIG. 23 is detailed view of DETAIL D in FIG. 21, in an example embodiment.

It will be recognized that the Figures are the schematic representations for purposes of illustration. The Figures are provided for the purpose of illustrating one or more implementations with the explicit understanding that the Figures will not be used to limit the scope of the meaning of the claims.

### DETAILED DESCRIPTION

Following below are more detailed descriptions of various concepts related to, and implementations for providing a kennel. The various concepts introduced above and discussed in greater detail below may be implemented in a number of ways, as the described concepts are not limited to any particular manner of implementation. Examples of specific implementations and applications are provided primarily for illustrative purposes.

### I. Overview

A kennel serves multiple purposes, including providing a place for a pet to rest and a method of transporting the pet. A common practice is to keep the kennel in a consistent, visible location within the home. Maintaining the location of the kennel encourages the pet to become familiar with the kennel as a safe and comfortable space, reducing anxiety during transport. For instance, if a dog associates the kennel with positive experiences like sleeping or resting, they are less likely to become scared or run away when the kennel is used for trips to the vet or other outings. Since the kennel is often placed in a prominent area of the home, pet owners may prefer the kennel to be aesthetically pleasing. A kennel that compliments the home décor can enhance the living space while providing a functional and comfortable environment for the pet. This consideration is important for pet owners who want to maintain a stylish and cohesive look in their homes while ensuring their pets can have a safe and familiar space to rest in on a daily basis and to travel in.

The present disclosure relates to a kennel including multiple interchangeable side panels, multiple connection pieces, a lid, and a base. Each of the side panels is configured to be slidably received within the lid and be locked in place by a fastener coupled to the lid. The side panels may be removed or replaced with alternate types of side panels (e.g., replacing a grated side panel with a plexiglass side panel, etc.) to customize the kennel or change the mode of the kennel to suit a user’s needs or a pet’s needs. The connection pieces may also be replaced with alternate styles of connection pieces (e.g., colors, textures, materials, etc.) to customize a visual appearance of the kennel. Protrusions extending from a base of the kennel may prevent a pet from opening the kennel from the inside. The kennel also includes a grate extending along the lid that may be hinged from multiple axes or removed. The present kennel may be more desirable than other kennels due to the ability to customize the kennel throughout the lifetime of the animal and easily disassemble and assemble the kennel without additional tools. The interchangeability of the side panels may be more desirable than other kennels due to the ability of the user to transform the kennel into a playpen, travel container, or bed as desired, in addition to customizing the overall aesthetic of the kennel. For example, the kennel can be configured in a variety of different modes that can suit a user’s desires or the needs of a pet, which may depend on an age or growth stage of the pet (e.g., puppy stage versus adult stage).

### II. Overview of Kennel

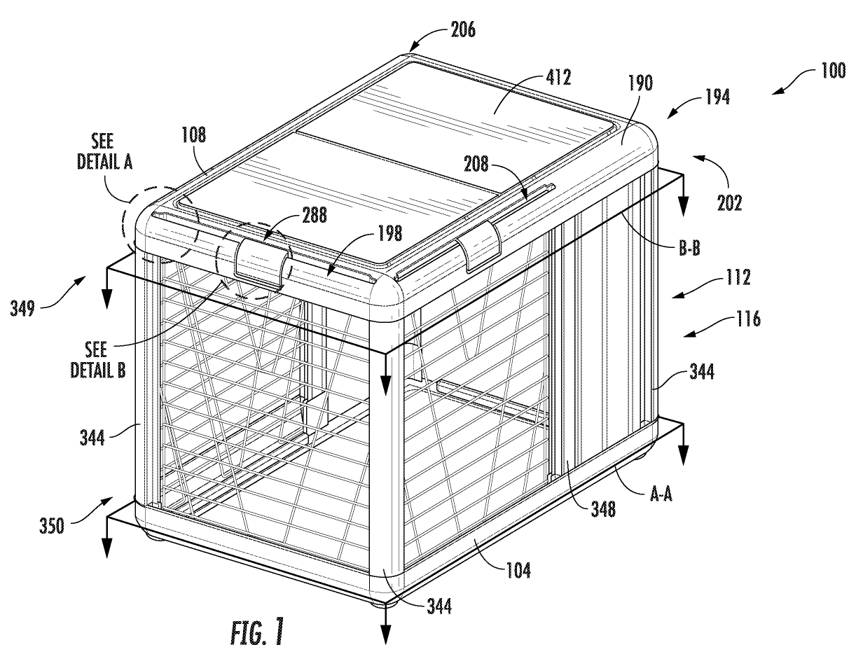

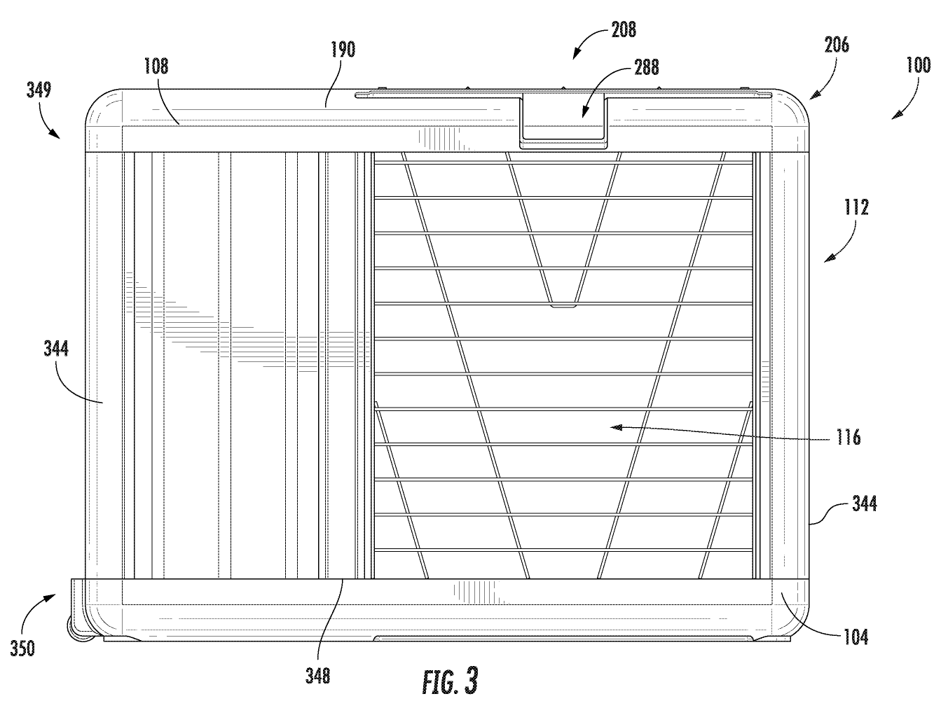

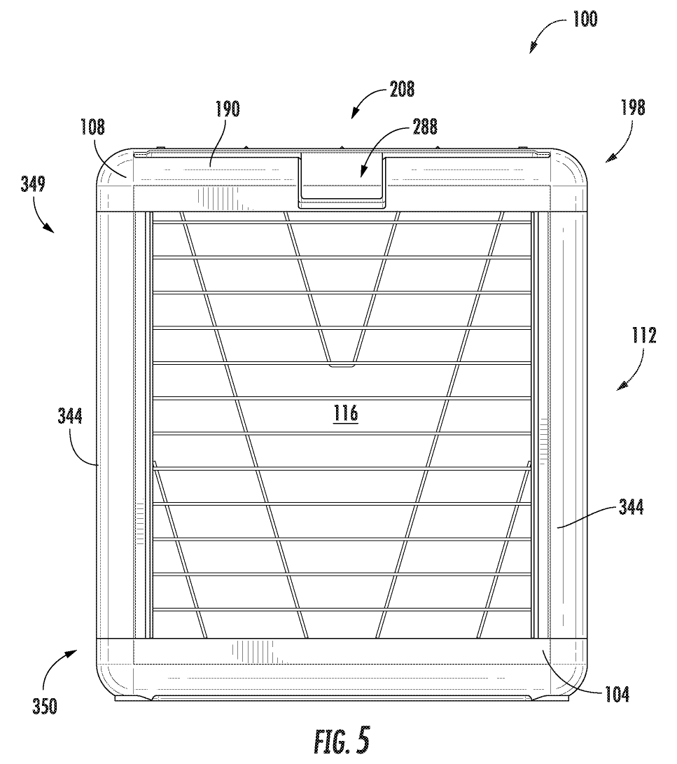

FIGS. 1–6 depict a kennel 100 (e.g., shelter, enclosure, crate, etc.) configured to house a pet (e.g., a dog, a cat, etc.). The kennel 100 forms a substantially rectangular prism volume. In some embodiments, the kennel 100 forms some other volume or has some other shape or form factor, or for example, the kennel 100 may form a cube volume, a trapezoidal volume, or some other volume. The kennel 100 includes a base 104 (e.g., bottom, floor, etc.) and a lid 108 (e.g., top, cover, etc.) offset from the base 104. The kennel 100 also includes a plurality of connection pieces 112 (e.g., supports, columns, pillars, posts, or other connection members) and a plurality of side panels 116 (e.g., side walls, partitions, screens, grates, or other panels). The connection pieces 112 extend between the base 104 and lid 108, and couple the base 104 to the lid 108. The side panels 116 are slidably received by the lid 108, the connection pieces 112, and the base 104. The side panels 116 may be removed or replaced in accordance with a user’s needs or a pet’s needs. In the illustrated embodiment, the side panels 116 are formed as metal grates, such as metal wire grates. In another example, the side panels 116 can be formed as solid panels, mesh screens, louvered panels, retractable panels (e.g., blinds) or some other form. In various examples, the side panels 116 can be or include a variety of materials, such as metal, some organic or non-organic material, polymeric materials, translucent or transparent materials, dense material or porous material, or some other material. The side panels 116 and the connection pieces 112 may also be replaced with alternate texture, material, color, or patterned side panels 116 and connection pieces 112 to fit the user’s preferences (e.g., leopard print connection pieces 112, blue side panels 116, or some other connection piece 112 or side panel 116 having some other design, pattern, texture, material or color). In the illustrated embodiment in FIGS. 1–6, three of the side panels 116 are slidably removable through the lid 108. In some embodiments, more than three side panels 116 may be slidably removable through the lid 108.

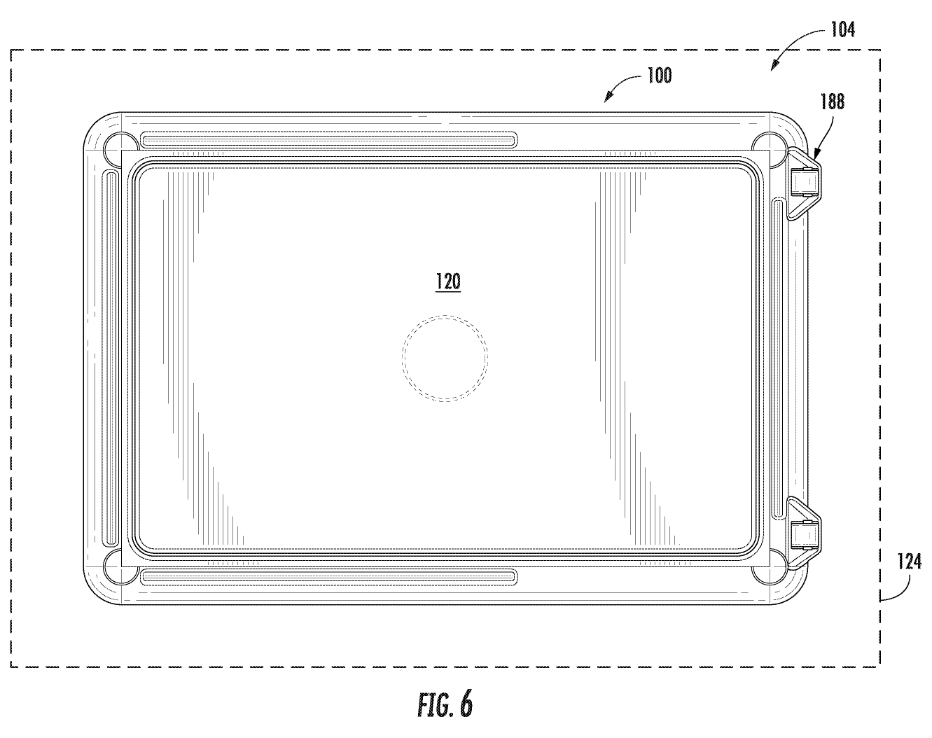

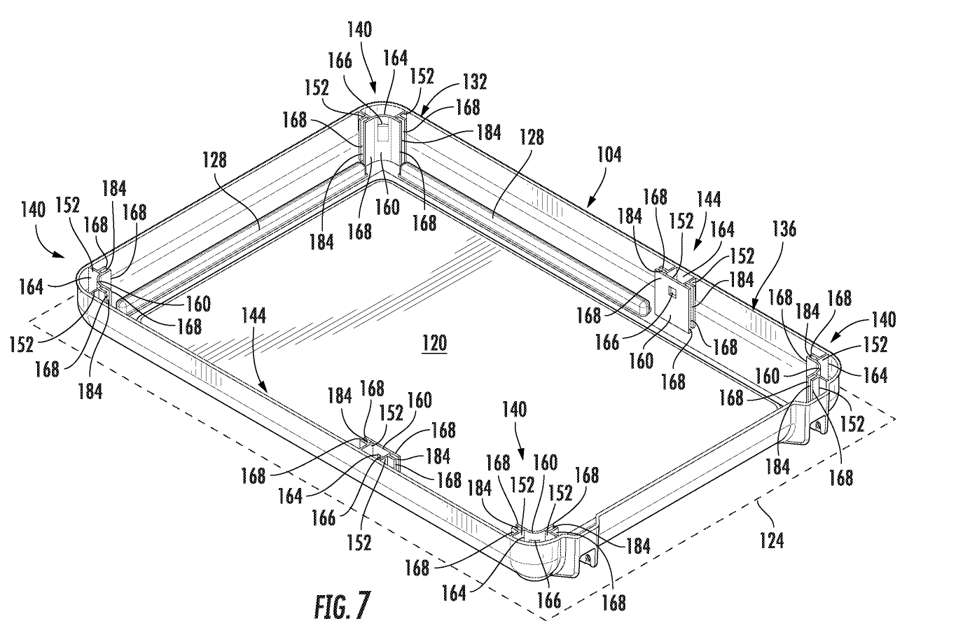

Referring now to FIGS. 6 and 7, the base 104 includes a bottom portion 120 (e.g., a floor, etc.). The bottom portion 120 extends substantially along a base plane 124 (e.g., a first plane, etc.). The base plane 124 is substantially perpendicular to the side panels 116 (e.g., ± 15° from perpendicular), according to an exemplary embodiment. Referring now to FIG. 7, the base 104 includes a plurality of base protrusions 128 (e.g., ridges, guides, etc.) and at least one outer wall 132 (e.g., base flange, perimetral wall, perimetral flange, extension portions, etc.) extending from the bottom portion 120 toward the lid 108, as shown in FIG. 7. The base protrusions 128 are shown with a generally elongate shape. In some embodiments, the plurality of base protrusions 128 includes a series of smaller, truncated protrusions. The plurality of base protrusions 128 and the outer wall 132 are each substantially perpendicular to the base plane 124 (e.g., ± 15° from perpendicular). The outer wall 132 is located farther outward relative to a center of the bottom portion 120 than the plurality of base protrusions 128. In the illustrated embodiment, there are three elongate base protrusions 128. In some embodiments, there may be more than three base protrusions 128. For example, when there are more than three side panels 116 there may be more than three base protrusions 128. In some embodiments, there may be less than two base protrusions 128. For example, when there are less than three side panels 116 there may be less than three base protrusions 128.

The base 104 includes the outer wall 132 extending from the bottom portion 120 toward the lid 108. The outer wall 132 extends from a bottom of the base 104 to a base lip 136, which forms an end of the outer wall 132. The outer wall 132 can have a curved, curvilinear, or linear form factor. An end portion of the outer wall 132 (e.g., a portion from which the base lip 136 extends) is substantially perpendicular (e.g., ± 15° from perpendicular) to the base plane 124. The base lip 136 is configured to vertically align with a lid lip 240 of the lid 108 when the kennel 100 is in an assembled state. In some examples, the base 104 can include a continuous outer wall 132 with a continuous or segmented base lip 136 (e.g., a plurality of base lip segments). In other examples, the base 104 can include a segmented outer wall 132 (e.g., a plurality of outer wall segments) with a continuous or segmented base lip 136.

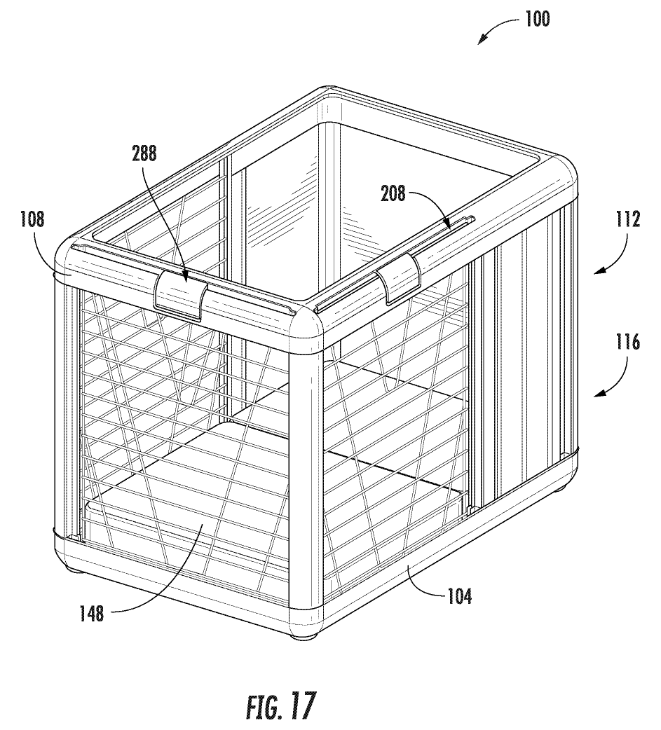

The base lip 136 extends around the perimeter of the bottom portion 120 (e.g., around a perimeter of the outer wall 132). The base lip 136 is configured to capture or retain a pillow 148 (e.g., a bed, a pad, etc.), as shown in FIGS. 17–19. The base lip 136 is also configured to prevent liquids (e.g., urine, etc.) from leaving the kennel 100. An end of each of the side panels 116 is configured to be captured between one of the base protrusions 128 and one of the base lips 136. This capturing feature reduces the ability of the pet to open the kennel 100 from the inside.

The outer wall 132 is coupled to or includes a plurality of base corner flanges 140 (e.g., corner piece receiving flanges, connection piece receiving flange, second flanges, etc.) and a plurality of intermediate base flanges 144 (e.g., side piece receiving flanges, connection piece receiving flange, third flanges, etc.). The base corner flanges 140 and the intermediate base flanges 144 each extend inward relative to the outer wall 132 toward the center of the bottom portion 120. Each of the base corner flanges 140 and each of the intermediate base flanges 144 are configured to slidably receive one of the connection pieces 112 and two of the side panels 116.

The base corner flanges 140 extend from a corner of the base 104. The intermediate base flanges 144 extend from a side of the base 104 between two of the base corner flanges 140. In the illustrated embodiment, there are four base corner flanges 140 and two intermediate base flanges 144. In some embodiments, there are more than two intermediate base flanges 144 (e.g., four intermediate base flanges 144, etc.) to capture additional side panels 116. In some embodiments, there are less than two intermediate base flanges 144 (e.g., the intermediate base flanges 144 are omitted) when there less side panels 116.

The base corner flanges 140 and the intermediate base flanges 144 each define two side portions 152 (e.g., a side wall, a side flange) and a middle portion 160 (e.g., a center wall, a center flange). The side portions 152 extend substantially perpendicularly (e.g., ± 15° from perpendicular) from the base lips 136. The middle portion 160 extends between two side portions 152. The middle portion 160 of the base corner flanges 140 forms an arc shape between the two side portions 152, similar to an arc shaped formed by a corner of the base lip 136. For example, at least one of the degree of curvature, the arc length, or the arc angle of the middle portion 160 of the base corner flange 140 may be the same as the arc formed by the corner of the base lip 136. The middle portion 160 of the intermediate base flanges 144 is substantially perpendicular (e.g., ± 15° from perpendicular) to the side portions 152. The middle portion 160 and the side portions 152 collectively define a stepped insert receiving channel 164 (e.g., first channel, connection piece receiving channel, etc.) configured to receive one the of the connection pieces 112. The stepped insert receiving channel 164 of the base corner flanges 140 is configured to receive a curved corner connection piece 112 and the stepped insert receiving channel 164 of the intermediate base flanges 144 is configured to receive a substantially rectangular connection piece 112. The middle portion 160 of each of the base corner flanges 140 and the intermediate base flanges 144 defines an aperture 166 (e.g., release aperture, connection piece access aperture, etc.) which is configured to provide access to the corresponding connection piece 112. The aperture 166 enables a user to release the connection piece 112 (e.g., a button of the connection piece 112 extends through the aperture 166).

The base corner flanges 140 and the intermediate base flanges 144 each define a plurality of extension portions 168 (e.g., protrusions, side flanges). Each of the extension portions 168 extend away from a side portion 152 and are substantially perpendicular (e.g., ± 15° from perpendicular) to the respective side portion 152. A pair of extension portions 168 extend from the side portion 152 to form a panel receiving channel 184 (e.g., a groove, a slot, a panel retaining passage). In embodiments where each base corner flanges 140 and intermediate base flanges 144 includes extension portions 168 extending from each of two side portions 152, each base corner flanges 140 and intermediate base flanges 144 includes two panel receiving channels 184. The panel receiving channels are 184 is configured to receive one of the side panels 116.

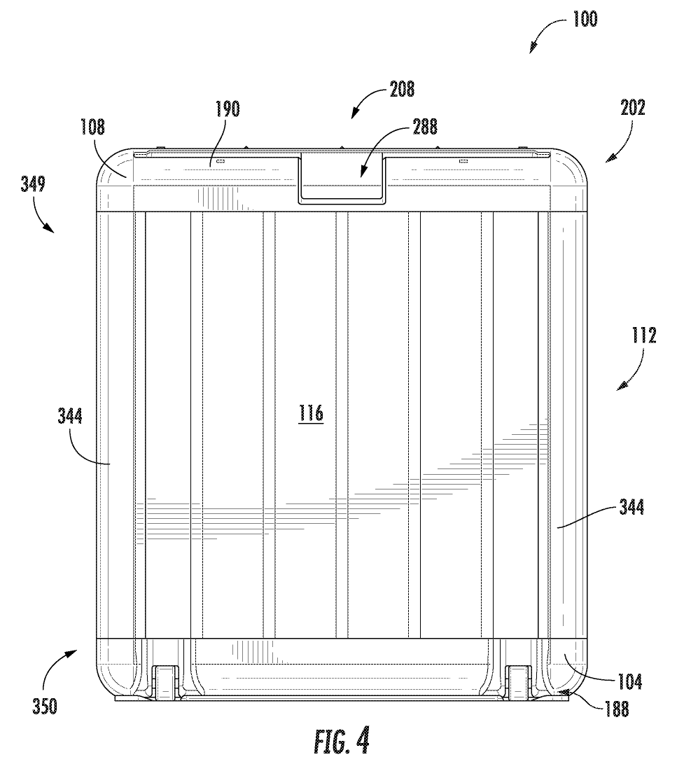

Referring now to FIGS. 4–6, the base 104 includes one or more wheels 188. The wheels 188 enable a user to slide around the kennel 100 and reduce the burden on a user when transporting a pet. The wheels 188 may be removed or coupled to the base 104 to customize the kennel 100. In the illustrated embodiment, the wheels 188 include two wheels 188 coupled to one edge of a bottom of the base 104. This arrangement of the wheels 188 enables a user to pull the kennel 100 along the wheels 188 with the kennel 100 tipped on an incline. In some embodiments, the kennel 100 includes four wheels 188 coupled to two edges of a bottom of the base 104, the edges opposite one another, enabling a user to roll the kennel 100 on a surface where the base plane 124 is substantially parallel (e.g., ± 15° from parallel). and offset to the ground.

Referring now to FIGS. 1–5, and 8, the lid 108 includes a body portion 190. The body portion 190 includes a right side 194 (e.g., a first side, etc.), a front side 198 (e.g., a second side, etc.), a back side 202 (e.g., a third side, etc.), and a left side 206 (e.g., a fourth side, etc.). The right side 194 is substantially parallel (e.g., ± 15° from parallel) to the left side 206 and the front side 198 is substantially parallel (e.g., ± 15° from parallel) to the back side 202. The front side 198 extends between the right side 194 and the left side 206 and the back side 202 extends between the right side 194 and the left side 206. The lid 108 defines a substantially rectangular perimeter. In some embodiments, the lid 108 defines an alternate perimeter (e.g., a square, etc.). In some embodiments, the lid 108 defines more than four sides. For example, the lid 108 may define a hexagon and include six sides. In some embodiments, the lid 108 defines less than four sides. For example, the lid 108 may define a circle and the kennel 100 may define a substantially circular shape.

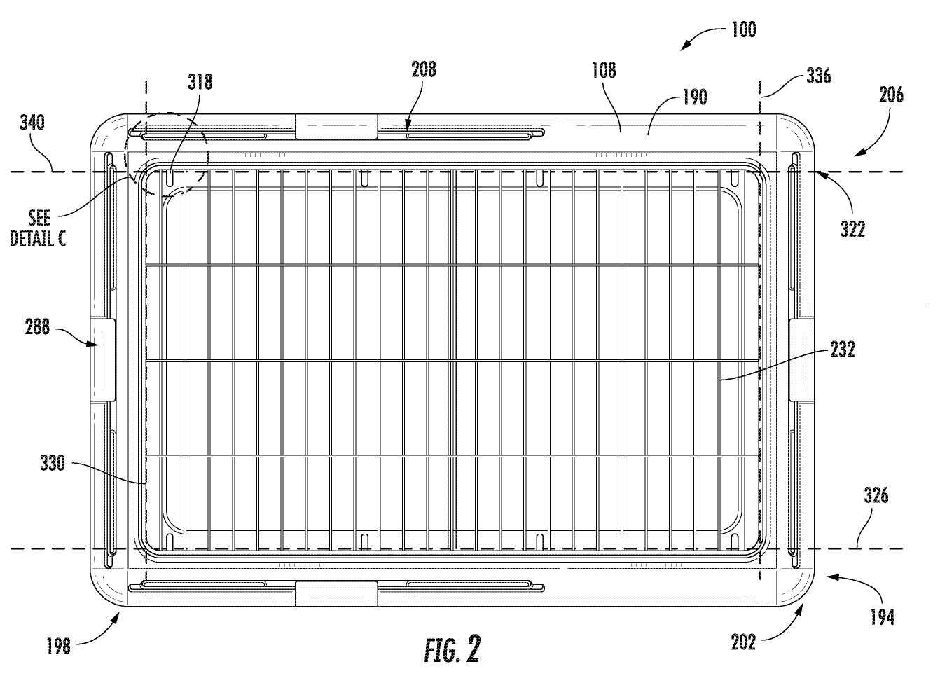

In the illustrated embodiment of FIG. 1, each of the right side 194, the front side 198, and the left side 206 of the lid 108 defines a side panel receiving aperture 208 (e.g., a body aperture, etc.) configured to slidably receive one of the side panels 116. In some embodiments, such as FIGS. 2, 4, and 8, the back side 202 also defines a side panel receiving aperture 208. In some embodiments, one or more of the sides define multiple side panel receiving apertures 208. For example, the solid side panel 116 in FIG. 1 may be slidably received within the right side 194 of the lid 108. To continue this example, the right side 194 may define two side panel receiving apertures 208, one of the side panel receiving apertures 208 configured to receive one of the grated side panels 116 and one of the side panel receiving apertures 208 configured to receive one of the solid side panels 116. Each of the side panel receiving apertures 208 are substantially equal (e.g., 90% equal) in length so as to interchangeably receive the side panels 116. In the illustrated embodiment, a length of the side panel receiving aperture 208 of the right side 194 is substantially equal to the length of the side panel receiving aperture 208 of the front side 198 and the side panel receiving aperture 208 of the back side 202. In some embodiments, the side panel receiving apertures 208 may include multiple or different lengths such that two different lengths of side panels 116 may be received within the kennel 100. For example, the right side 194 may define two side panel receiving apertures 208, where one of the side panel receiving apertures 208 may be longer than the other one of the side panel receiving apertures 208. In another example, the right side 194 may define a side panel receiving aperture 208 having a first length to receive a side panel 116 of a first dimension while the front side 198 may define a side panel receiving aperture 208 having a second length to receive a side panel 116 of a second dimension (e.g., the first length is greater than the second length, the second length is greater than the first length, etc.).

Referring now to FIG. 8, the body portion 190 includes a lower lid portion 212 (e.g., a first portion, a peripheral lid portion, etc.) and an upper lid portion 216 (e.g., a center lid portion, a second portion, etc.). The lower lid portion 212 extends along a lower lid plane 224 (e.g., a second plane, etc.) and the upper lid portion 216 extends along an upper lid plane 220 (e.g., a third plane, etc.). The lower lid plane 224 is offset from the upper lid plane 220. The base plane 124 is located closer to the lower lid plane 224 than the upper lid plane 220. The upper lid portion 216 defines a center aperture 228 configured to receive a grate 232, as shown in FIG. 2. The grate 232 is configured to cover at least a portion of the center aperture 228.

The lid 108 includes an outer wall 236 (e.g., lid flange, perimetral wall, perimetral flange, extension portions, etc.) extending from the body portion 190 towards the base 104. The outer wall 236 extends from a top of the lid 108 to a lid lip 240, which forms an end of the outer wall 236. An end portion of the outer wall 236 (e.g., a portion from which the lid lip 240 extends) is substantially perpendicular (e.g., ± 15° from perpendicular) to the lower lid plane 224. The lid lip 240 is configured to vertically align with the base lip 136 of the base 104 when the kennel 100 is in an assembled state. In some examples, the lid 108 can include a continuous outer wall 236 with a continuous or segmented lid lip 240 (e.g., a plurality of lid lip segments). In other examples, the lid 108 can include a segmented outer wall 236 (e.g., a plurality of outer wall segments) with a continuous or segmented lid lip 240.

The outer wall 236 is coupled to or includes a plurality of lid corner flanges 244 (e.g., corner piece receiving flanges, connection piece receiving flange, second flanges, etc.). The lid corner flanges 244 are configured to vertically align with the base corner flanges 140 of the base 104 when the kennel 100 is in an assembled state. The lid corner flanges 244 extend inward relative to the outer wall 236 toward a center of the lid 108. Each of the lid corner flanges 244 is configured to slidably receive one of the connection pieces 112 and two of the side panels 116.

The outer wall 236 of the lid 108 is coupled to or includes a plurality of intermediate lid flanges 248 (e.g., side piece receiving flanges, connection piece receiving flange, third flanges, etc.). The intermediate lid flanges 248 are configured to vertically align with the intermediate base flanges 144 of the base 104 with the kennel 100 in an assembled state. The intermediate lid flanges 248 extend from a side of the lid 108 between two of the lid corner flanges 244. The intermediate lid flanges 248 each extend from the lid lips 240 towards the center of the lid 108. Each of the intermediate lid flanges 248 are configured to slidably receive one of the connection pieces 112 and two of the side panels 116. In the illustrated embodiment, there are four of the lid corner flanges 244 and two of the intermediate lid flanges 248. In some embodiments, there are more than two intermediate lid flanges 248 (e.g., four intermediate lid flanges 248, etc.) to capture additional side panels 116. In some embodiments, there are less than two intermediate lid flanges 248 (e.g., the intermediate lid flanges 248 are omitted) when there less side panels 116. Two of the side panel receiving apertures 208 extend between one of the lid corner flanges 244 and one of the intermediate lid flanges 248. Two of the side panel receiving apertures 208 extend between two of the lid corner flanges 244.

The lid corner flanges 244 and the intermediate lid flanges 248 each define at least one side portion 252 (e.g., a side wall, a side flange, first and second side portions, etc.) and a middle portion 260 (e.g., a center portion, a third portion, a center flange, etc.). As shown, the lid corner flanges 244 and the intermediate lid flanges 248 include two left side portions 252. The side portions 252 each extend substantially perpendicularly (e.g., ± 15° from perpendicular) from the lid lips 240. The middle portion 260 extends between the side portions 252. The middle portion 260 of the lid corner flange 244 forms an arc shape similar to an arc shaped formed by a corner of the lid lips 240. For example, at least one of the degree of curvature, the arc length, or the arc angle of the middle portion 260 of the lid corner flange 244 may be the same as the arc formed by the corner of the lid lips 240. The middle portion 260 of the intermediate lid flanges 248 is substantially perpendicular (e.g., ± 15° from perpendicular) to the side portions 252. The middle portion 260 and the side portions 252 define a stepped insert receiving channel 264 (e.g., first channel, flange channel, etc.) configured to receive one of the connection pieces 112. The stepped insert receiving channel 264 of the lid corner flanges 244 is configured to receive a curved corner connection piece 112 and the stepped insert receiving channel 264 of the intermediate lid flanges 248 is configured to receive a substantially rectangular connection piece 112. The middle portion 260 of each of the lid corner flanges 244 and the intermediate lid flanges 248 defines an aperture 266 (e.g., release aperture, connection piece access aperture, etc.). The aperture 266 is configured to provide access to the corresponding connection piece 112. The aperture 266 is configured to receive at least a portion of the corresponding connection piece 112. The aperture 266 enables a user to release the connection piece 112 (e.g., a button of the connection piece 112 extends through the aperture 266).

The lid corner flanges 244 and the intermediate lid flanges 248 each define a plurality of extension portions 268 (e.g., protrusions, side flanges). Each of the extension portions 268 extend away from a side portion 252 and are substantially perpendicular (e.g., ± 15° from perpendicular) to the side portion 252. Pairs of extension portions 268 define a panel receiving channels 284 (e.g., a groove, a slot, a panel retaining passage). In embodiments where each of the lid corner flanges 244 and intermediate lid flanges 248 include extension portions 268 extending from each of two side portions 252, each lid corner flanges 244 and intermediate lid flanges 248 includes two panel receiving channels 284. The panel receiving channels are 284 is configured to receive one of the side panels 116

Referring now to FIGS. 1–5 and 10, the lid 108 includes a plurality of side panel receiving fasteners 288 (e.g., first fasteners). The side panel receiving fasteners 288 are coupled to the body portion 190. At least a portion of each of the side panel receiving fasteners 288 is disposed within a corresponding side panel receiving aperture 208. Each of the side panel receiving fasteners 288 is configured to move between a locked position and an unlocked position. In the locked position, the fastener 288 is configured to prevent the corresponding side panel(s) 116 from being removed from the kennel 100 (e.g., removed from the lid 108 via the corresponding side panel receiving aperture 208). In the unlocked position, the fastener 288 enables a side panel 116 to be removed (e.g., removed from the lid 108 via the corresponding side panel receiving aperture 208). In some embodiments, such as FIG. 2, there are four side panel receiving fasteners 288, one for each side of the kennel 100. In some embodiments, such as FIG. 1, there are less than four side panel receiving fasteners 288. For example, one of the side panels 116 of the kennel 100 may not be removable through a side panel receiving aperture 208 (e.g., the side panel 116 can be captured between the lid 108 and the base 104 such that the side panel 116 cannot be removed). In such instances, a fastener 288 is not required to selectively retain the side panel 116 within the kennel 100. In some embodiments, there are more than four side panel receiving fasteners 288. For example, there may be a kennel 100 including two side panels 116 on each side of the kennel 100, and therefore eight side panel receiving fasteners 288 to lock all of the side panels 116 in place.

Referring now to FIG. 10, each of the side panel receiving fasteners 288 includes an outer piece 292 (e.g., a first piece, base piece, etc.) and an inner piece 296 (e.g., a second piece, etc.). The outer piece 292 includes a curved base 300 (e.g., an outer portion, etc.), a pair of lower protrusions 304 (e.g., an inner piece engaging protrusion etc.), and an upper protrusion 312 (e.g., side panel engaging protrusion, side panel receiving protrusion, etc.). The lower protrusions 304 extend from the curved base 300 and define an aperture 309 (e.g., a first aperture, etc.). The pair of lower left protrusion 304 are spaced apart (e.g., offset). The lower protrusions 304 are substantially parallel (e.g., ± 15° from parallel) to each other. The upper protrusion 312 extends from the curved base 300. The curved base 300 is adapted for actuation.

In the locked state, the upper protrusion 312 extends within a corresponding one of the side panel receiving apertures 208 and around at least a portion of the corresponding one of the side panels 116 to retain the side panel 116 between the curved base 300 and the upper protrusion 312. In the locked state, at least a portion of one of the side panels 116 is locked in place by the inner piece 296. A lower end of the inner piece 296 is configured to extend between the lower protrusions 304, and the lower end of the inner piece 296 is received within the apertures 309 of the lower protrusions 304. The lower end of the inner piece 296 extends along a lower cantilever axis 311 and is configured to rotate about the lower cantilever axis 311. An upper end of the inner piece 296 is also configured to be received within the body portion 190 of the lid 108. The upper end of the inner piece 296 extends along an upper cantilever axis 313 and is configured to rotate about the upper cantilever axis 313.

To unlock the side panel receiving fasteners 288, the curved base 300 is pulled up (e.g., actuated, etc.), enabling the inner piece 296 to act as a cantilever and release a portion of the side panels 116. For example, when the curved base 300 is pulled up, the lower end of the inner piece 296 is pulled back with the curved base 300 and the lower end of the inner piece 296 rotates about the lower cantilever axis 311. During this motion, the upper end of the inner piece 296 remains within the body portion 190 of the lid 108, and the upper end of the inner piece 296 rotates about the upper cantilever axis 313. This creates a clearance (e.g., space, gap, opening) enabling the upper protrusion 312 and the curved base to disengage from the side panel 116.

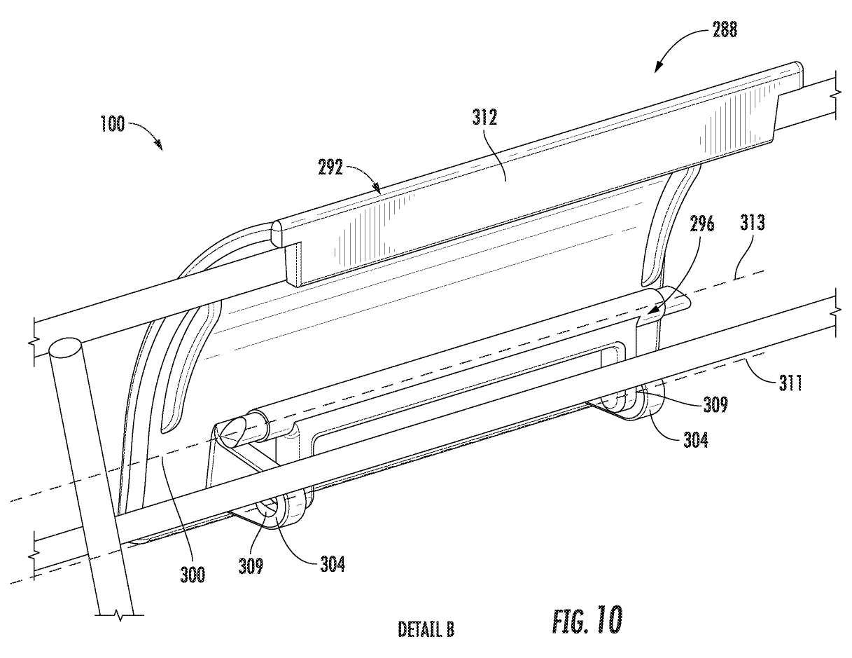

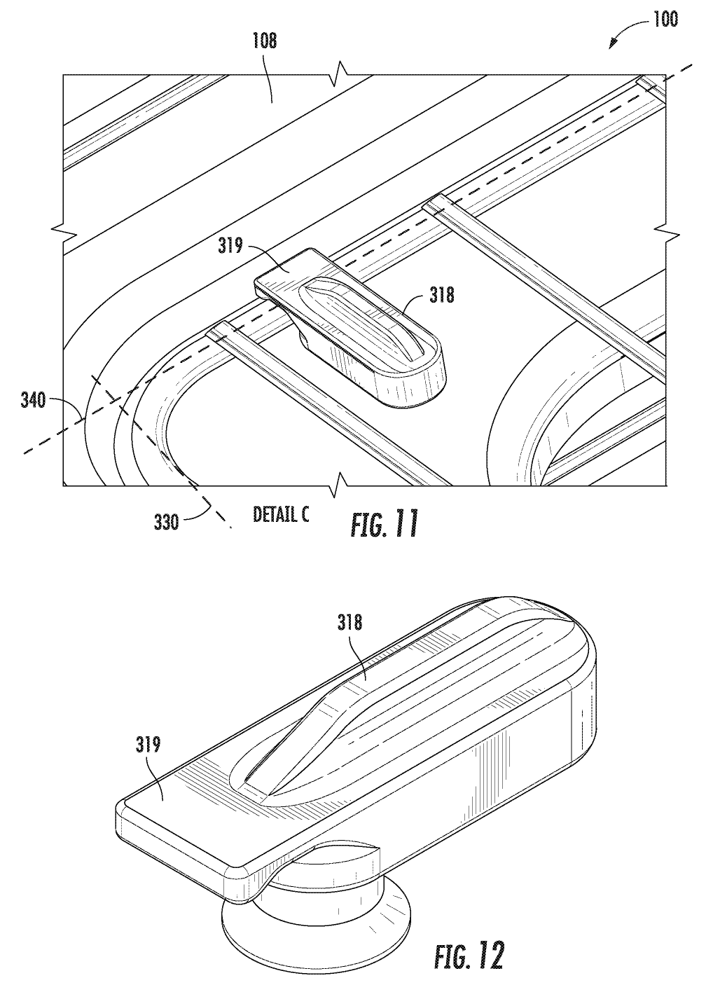

Referring now to FIGS. 2, 11, and 12 the lid 108 includes a plurality of grate receiving fasteners 318 (e.g., second fasteners). Each of the grate receiving fasteners 318 is coupled to the upper lid portion 216 of the lid 108 and is positioned around at least a portion of the grate 232 to retain the grate 232 against the lid 108. For example, multiple grate receiving fasteners 318 can be positioned around a perimeter of the grate 232. The grate receiving fasteners 318 are configured to couple to the grate 232 and facilitate hinging the grate 232 along multiple axes 322 or removing the grate 232. For example, the grate receiving fasteners 318 can include an upper end 319 that wraps around or receives a portion of the grate 232 (e.g., a single wire of the grate 232). The grate receiving fasteners 318 are configured to be rotated to couple or decouple from the grate 232. For example, the grate receiving fasteners 318 may each be configured to approximately rotate 90 degrees (e.g., ±15º) to couple or de-couple to the grate 232. In one example, the grate receiving fasteners 318 positioned on one side (e.g., the right side, etc.) of the grate 232 can be rotated and disengaged with the grate 232 with grate receiving fasteners 318 positioned on an opposing side (e.g., the left side, etc.) of the grate 232 still engaged with the grate 232. In such a configuration, the portion of the grate 232 (e.g., the left side, etc.) retained by the upper end 319 of the grate receiving fastener 318 can rotate between the upper end 319 of the grate receiving fastener 318 and the lid 108 to pivot (e.g., hinge) the grate 232 relative to the lid 108. Accordingly, the grate 232 may be hinged along various axes, including a right axis 326 (e.g., a first axis, etc.), a front axis 330 (e.g., a second axis, etc.), a back axis 336 (e.g., a third axis, etc.), or a left axis 340 (e.g., a fourth axis, etc.) so that the grate 232 can be opened from a variety of different sides of the kennel 100. In some embodiments, the plurality of grate receiving fasteners 318 are configured to be simultaneously rotated (e.g., multiple grate receiving fasteners 318 are coupled together and a user may rotate a single one of the grate receiving fasteners 318 on one side of the lid 108 to rotate all of the grate receiving fasteners 318 on the same side of the lid 108, etc.).

Referring now to FIGS. 1, 3–5, and 14 the connection pieces 112 include a plurality of corner pieces 344 and a plurality of intermediate pieces 348 (e.g., side pieces, etc.). Each of the corner pieces 344 extends between a corner of the lid 108 and a corner of the base 104. Each of the intermediate pieces 348 is offset from the corners of the lid 108 and the corners of the base 104. Each of the connection pieces 112 includes an upper end 349 (e.g., a first end, a lid contacting end, etc.) and a lower end 350 (e.g., a second end, base contacting end, etc.). The upper end 349 is opposite the lower end 350. The upper end 349 is configured to contact the outer wall 236 of the lid 108, and the lower end 350 is configured to contact the outer wall of the base 104.

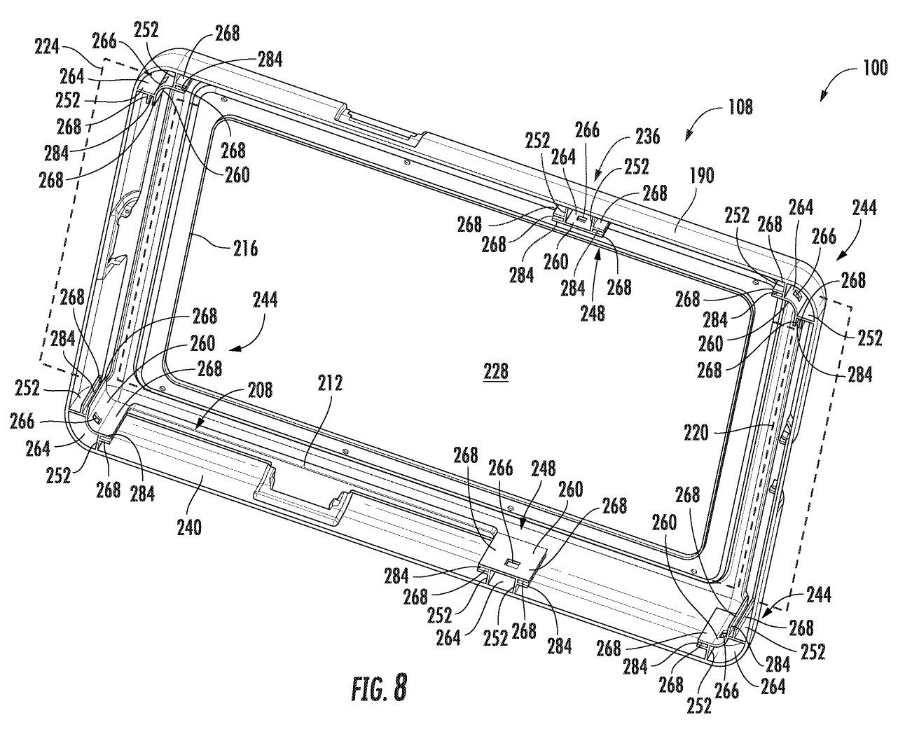

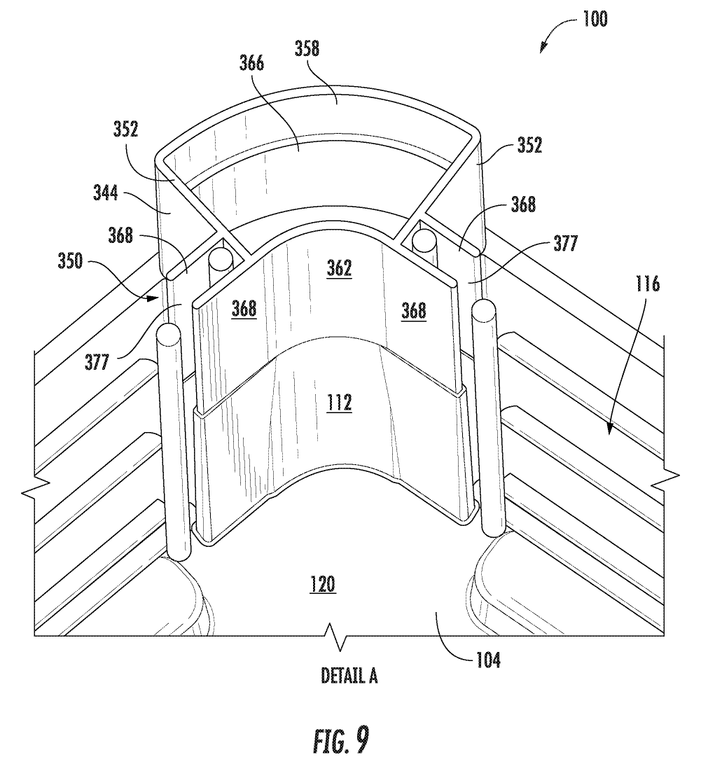

Referring now to FIG. 9, each of the upper end 349 and the lower end 350 of the connection pieces 112 includes a plurality of side portions, a back middle portion 358 (e.g., a first middle portion, exterior middle portion, etc.), and a front middle portion 362 (e.g., second middle portion, interior middle portion, etc.). The side portions 352 each extend between the back middle portion 358 and the front middle portion 362. The side portions 352, the back middle portion 358, and the front middle portion 362 define a stepped insert receiving channel 366 (e.g., first channel, etc.). The stepped insert receiving channel 366 of the connection piece 112 is configured to align with the stepped insert receiving channels 264 of the lid corner flanges 244 and the intermediate lid flanges 248. The stepped insert receiving channel 366 is configured to align with the stepped insert receiving channels 164 of the base corner flanges 140 and the intermediate base flanges 144.

Each of the upper end 349 and the lower end 350 of the connection pieces 112 includes a plurality of extension portions 368 (e.g., protrusions, side flanges). Each of the extension portions 368 extend away from a side portion 352 and are substantially perpendicular (e.g., ± 15° from perpendicular) to the respective side portion 352. Pairs of adjacent extension portions 368 define a side panel receiving channel 377 that is configured to receive one of the side panels 116. The side panel receiving channels 377 are configured to align with the side panel receiving channel 184 of the base 104 and the side panel receiving channel 284 of the lid 108.

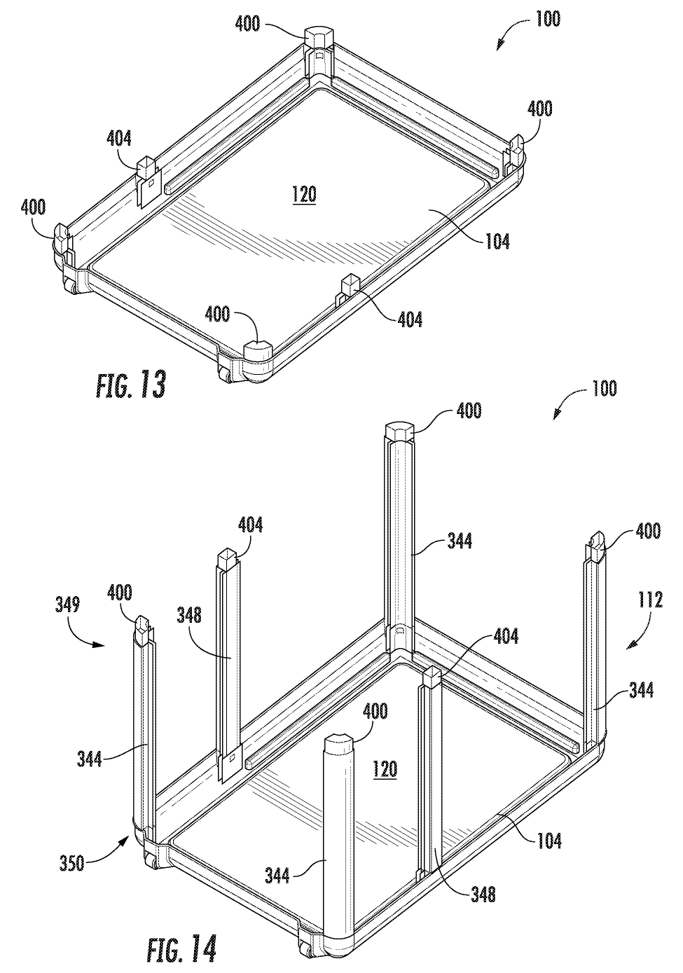

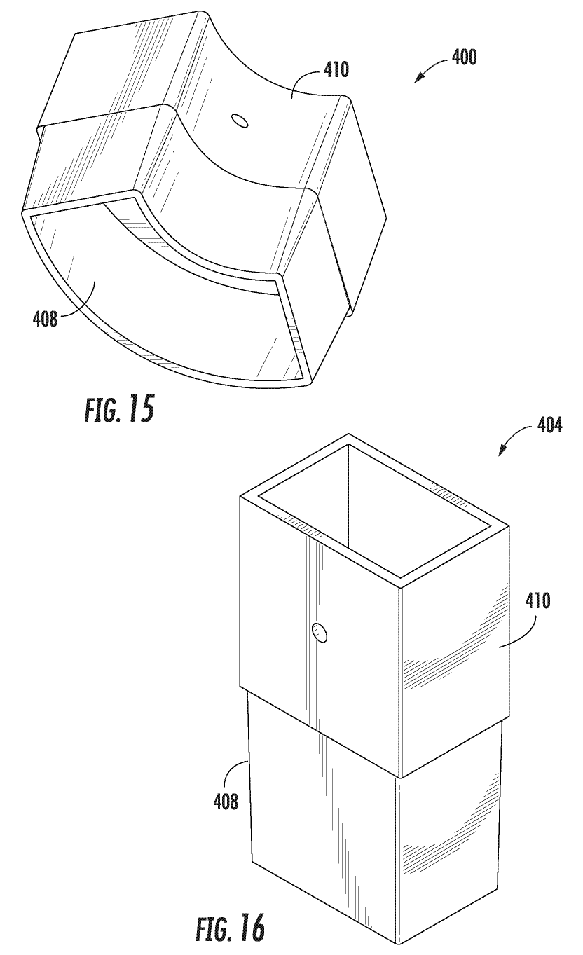

Referring now to FIGS. 9 and 13–16, the kennel 100 includes a plurality of corner stepped inserts 400 (e.g., first stepped inserts, etc.) and a plurality of intermediate stepped inserts 404 (e.g., second stepped insert, etc.). FIG. 13 depicts a perspective view of a portion of the kennel 100 along plane A–A in FIGS. 1, and 14 depicts a perspective view of a portion of the kennel 100 along plane B–B in FIG. 1. Each of the corner stepped inserts 400 and the intermediate stepped inserts 404 are configured to be coupled between one of the connection pieces 112 and the lid 108, or between one of the connection pieces 112 and the base 104. The corner stepped inserts 400 and the intermediate stepped inserts 404 are spring loaded and may be disassembled by interacting with a button (not shown) on the corner stepped inserts 400 or the intermediate stepped inserts 404. One of the corner stepped inserts 400 is configured to be received within the stepped insert receiving channel 366 of the upper end 349 of a corresponding one of the corner pieces 344 and within the stepped insert receiving channel 264 of the lid 108. One of the corner stepped inserts 400 is configured to be received within the stepped insert receiving channel 366 of the lower end 350 of the corresponding one of the corner pieces 344 and within the stepped insert receiving channel 164 of the base 104. One of the intermediate stepped inserts 404 is configured to be received within the stepped insert receiving channel 366 of the upper end 349 of a corresponding one of the intermediate pieces 348 and within the stepped insert receiving channel 264 of the lid 108. One of the intermediate stepped inserts 404 is configured to couple within the stepped insert receiving channel 366 of the lower end 350 of the corresponding one of the intermediate pieces 348 and within the stepped insert receiving channel 164 of the base 104.

Each of the corner stepped inserts 400 and the intermediate stepped inserts 404 includes an exterior facing section 408 (e.g., a first section, etc.) and an interior facing section 410 (e.g., a second section, a connection piece coupling section, etc.). The exterior facing section 408 includes a smaller cross-sectional area than the interior facing section 410. The exterior facing section 408 is configured to be received within the stepped insert receiving channel 164 of the base 104 or the stepped insert receiving channel 264 of the lid 108. The interior facing section 410 is configured to be received within the stepped insert receiving channel 264 of the connection pieces 112. The corner stepped inserts 400 and the intermediate stepped inserts 404 are not visible when the kennel 100 is assembled.

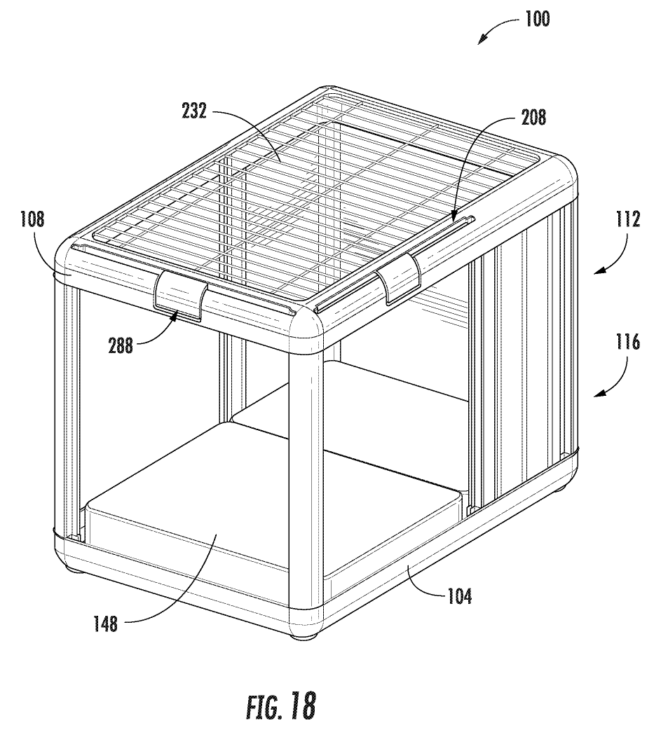

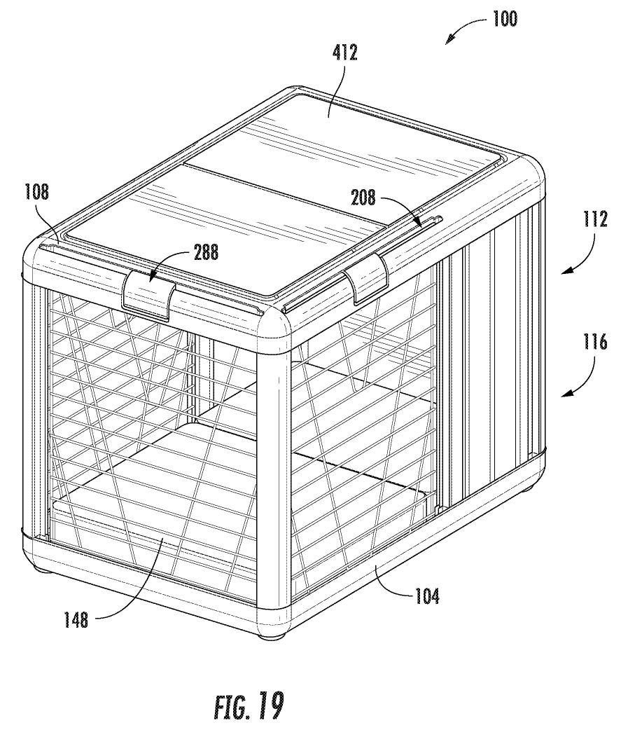

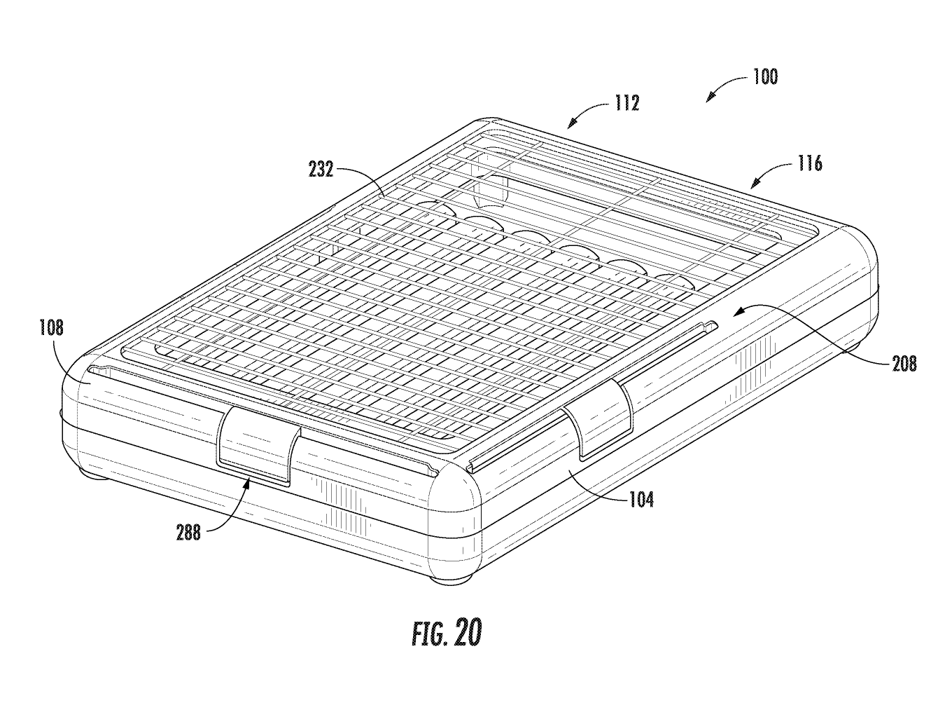

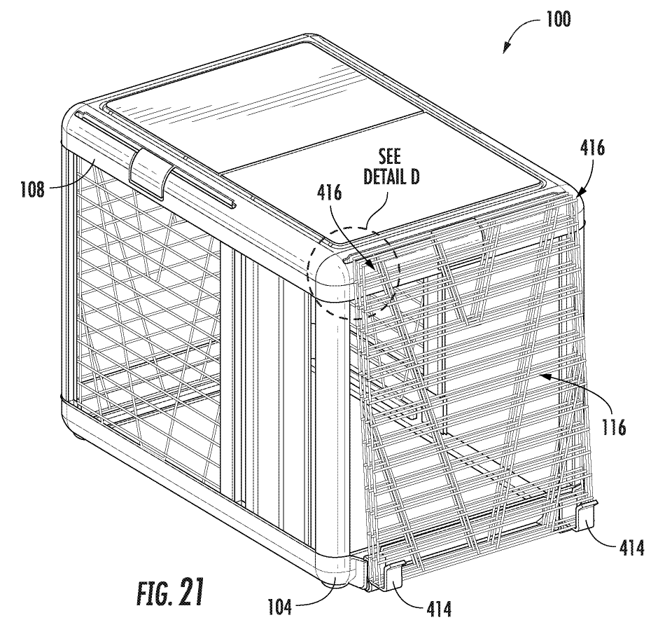

Referring now to FIG. 17, in some embodiments the grate 232 may be removed and all of the side panels 116 may be inserted and locked in place to create a play pen configuration of the kennel 100 (e.g., for a puppy, etc.). Referring now to FIG. 18, in some embodiments the grate 232 be inserted and some of the side panels 116 may be removed to create a den configuration of the kennel 100 (e.g., a bed, an everyday space, etc.) for the animal. Referring now to FIG. 19, in some embodiments, the kennel 100 includes a cover 412. The cover 412 is configured to cover the grate 232. In some embodiments, the cover 412 is a bi-fold cover, enabling a first side or a second side to of the cover 412 to be folded. Referring now to FIG. 20, the kennel 100 may be easily disassembled for shipping or storage. The disassembled kennel 100 is configured to slide within a small space (e.g., under a bed, etc.). The kennel 100 may include the connection pieces 112, the side panels 116, the plurality of corner pieces 344, the plurality of intermediate pieces 348, the pillow 148, and the plurality of wheels 188 disposed between the base 104 and the lid 108. The kennel 100 may include an additional fastener to fasten the base 104 to the lid 108.

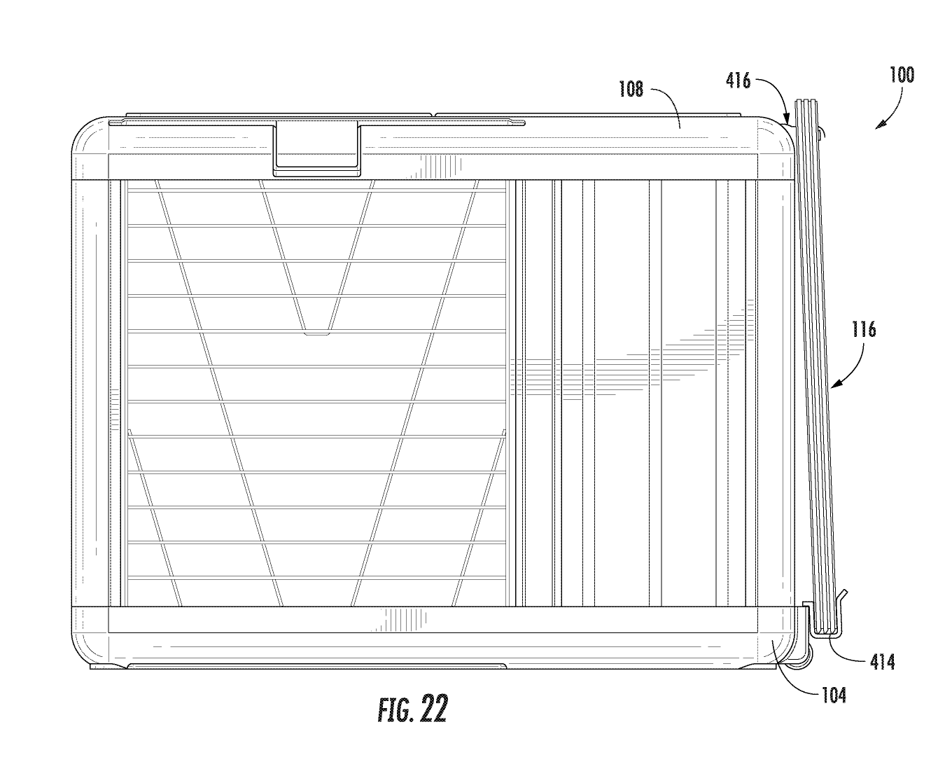

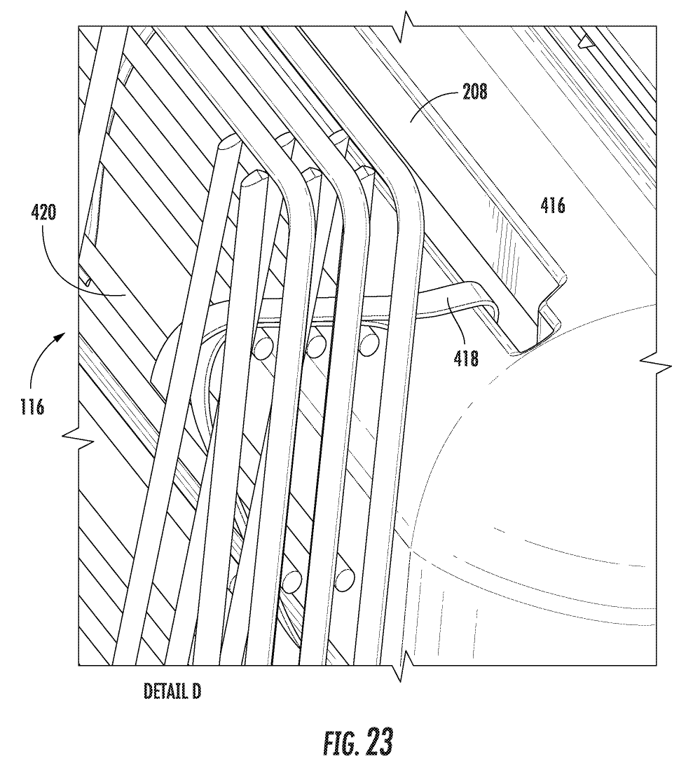

Referring now to FIG. 21–23 in some embodiments the kennel 100 includes a plurality of lower panel fasteners 414 (e.g., first panel fasteners, etc.) and a plurality of upper panel fasteners 416 (e.g., second panel fasteners, etc.). The lower panel fasteners 414 are coupled to the base 104 and vertically aligned with the wheels 188. The lower panel fasteners 414 are configured to receive a first, or lower, end of the one or more unused side panels 116 to store the side panels 116. The upper panel fasteners 416 couple a second, or upper, end of the unused side panels 116 to the lid 108. The upper panel fasteners 416 include a tie strap 418 and a panel receiving portion 420 (e.g., a rod, etc.). The tie strap 418 extends within one of the side panel receiving apertures 208, and the panel receiving portion 420 extends from the tie strap 418. The panel receiving portion 420 is configured to receive the side panels 116 and separate the side panels 116 from one another. The lower panel fasteners 414 and the upper panel fasteners 416 enable a user to store multiple unused side panels 116 while maintaining aesthetics of the kennel 100.

In some embodiments, the kennel 100 may include slots for storing unused side panels 116. For example, the base 104 may include a slot disposed along the bottom portion 120 configured to store unused side panels 116. In some embodiments, unused or replacement side panels 116 may be stored between the pillow 148 and the bottom portion 120.

### III. Configuration of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable, or releasable). Such joining may be achieved with the two components, or the two components and any additional intermediate components being integrally formed as a single monolithically body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

What is claimed is:

1. A kennel comprising:
a base;
a plurality of connection pieces, each of the connection pieces including a lower end coupled to the base and an upper end, spaced from the lower end;
a lid including a plurality of side panel receiving fasteners, each of the side panel receiving fasteners configured to move between a locked position and an unlocked position, the upper end of each of the connection pieces coupled to the lid; and
a plurality of side panels, each of the side panels coupled to the lid when a corresponding one of the side panel fasteners is in the locked position;
wherein the lid includes a plurality of apertures and the connection pieces each include a plurality of connection piece channels and, in the unlocked position the side panel fastener is configured to permit the corresponding side panel to be received within at least one of the connection piece channels via one or the apertures.

2. The kennel of claim 1, wherein the base includes:
a bottom portion substantially perpendicular to the plurality of side panels and having a center;
an outer wall extending from the bottom portion towards the lid; and
a plurality of base protrusions extending from the bottom portion towards the lid; the outer wall located farther from the center of the bottom portion than the base protrusions;
wherein each of the side panels includes a lower end configured to be captured between one of the base protrusions and the outer wall.

3. The kennel of claim 2, wherein the base includes a plurality of base flanges extending from the bottom portion towards the lid, each of the base flanges located farther from the center of the bottom portion than the base protrusions, the base flanges each including a base channel, the lower end of the corresponding one of the side panels configured to be received within one of the base channels.

4. The kennel of claim 1, wherein:
the base includes a plurality of base flanges extending towards the lid, each of the base flanges defining a base channel;
the lid includes a plurality of lid flanges extending towards the base, each of the lid flanges defining a lid channel; and
each of the side panels is configured to be received within at least one of the base channels, at least one of the lid channels, and at least one of the connection piece channels.

5. The kennel of claim 4, wherein at least one of the base flanges or the lid flanges defines a release aperture configured to provide access to a portion of the corresponding connection piece, and enables the connection piece to be released from at least one of the base or the lid.

6. The kennel of claim 1, wherein the lid includes:
a body portion including the apertures, the side panel receiving fasteners coupled to the body portion; and
a plurality of lid flanges extending from the body portion towards the base, each of the lid flanges defining a plurality of lid channel;
wherein each of the side panels is configured to be received within at least one of the lid channels.

7. The kennel of claim 1, wherein the kennel further comprises:
a plurality of stepped inserts, the upper end of a corresponding one of the connection pieces and the lid configured to couple to one of the stepped inserts, and the lower end of a corresponding one of the connection pieces and the base configured to couple to one of the stepped inserts.

8. The kennel of claim 7, wherein:
the lid includes a stepped insert receiving lid channel;
the base includes a stepped insert receiving base channel;
the connection pieces each include a stepped insert receiving channel; and
each of the stepped inserts includes:
an exterior facing section configured to be received by the stepped insert receiving lid channel in the lid or the stepped insert receiving base channel in the base; and
an interior facing section configured to be received by the stepped insert receiving channel in one of the connection pieces, the exterior facing section including a smaller cross-sectional area than the interior facing section.

9. The kennel of claim 1, wherein the plurality of side panels include at least two panels having a differing material.

10. The kennel of claim 1, wherein each of the side panel fasteners includes:
an outer piece including:
a curved base adapted for actuation;
a pair of lower protrusions offset from one another and extending from the curved base; and
an upper protrusion extending from the curved base and configured to couple to one of the side panels in the locked position; and
an inner piece extending between the pair of lower protrusions, the inner piece configured to rotate relative to the pair of lower protrusions;
wherein actuating the curved base causes the inner piece to act as a cantilever and disengages the upper protrusion from the side panel, permitting the side panel to be removed from the kennel.

11. The kennel of claim 1, wherein:
the apertures include a front aperture, a right aperture, and a left aperture; and
the lid includes:
a front side defining the front aperture;
a right side defining the right aperture; and
a left side defining the left aperture, the front side extending between the right side and the left side.

12. The kennel of claim 1, wherein:
the lid includes a lid corner;
the base includes a base corner; and
the plurality of connection pieces includes:
a plurality of corner pieces, each of corner pieces extending between the lid corner and the base corner; and
a plurality of intermediate pieces, each of the intermediate pieces offset from the lid corner and the base corner.

13. The kennel of claim 12, wherein each of the corner pieces includes a lower end and an upper end and each of the intermediate piece includes a lower end and an upper end, the kennel further comprising:
a plurality of corner stepped inserts, each of the corner pieces configured to receive one of the corner stepped inserts in the upper end of the corner piece and one of the corner stepped inserts in the lower end of the corner piece; and
a plurality of intermediate stepped inserts, each of the intermediate pieces configured to receive one of the intermediate stepped inserts in the upper end of the intermediate piece and one of the intermediate stepped inserts in the lower end of the intermediate piece.

14. The kennel of claim 1, wherein the lid defines a center aperture, the kennel further comprising:
a grate coupled to the lid and covering at least a portion of the center aperture; and
a plurality of grate receiving fasteners coupled to the lid, each of the grate receiving fasteners configured to retain a portion of the grate against the lid and permit the grate to rotate.

15. The kennel of claim 14, further comprising a bi-fold cover supported by the grate.

16. The kennel of claim 1, further comprising a plurality of wheels removably coupled to the base.

17. The kennel of claim 1, wherein each of the side panels extends between a lower end and an upper end, the kennel further comprising:
a plurality of lower panel fasteners coupled to the base, the lower panel fasteners configured to retain the lower end of one or more of the side panels in a stored position; and
a plurality of upper panel fasteners coupled to the lid and configured to couple to the upper end of one or more of the side panels in the stored position.

18. The kennel of claim 17, further comprising a plurality of wheels removably coupled to the base, each of the lower panel fasteners vertically aligned with a corresponding one of the wheels.

19. A kennel for an animal comprising:
a base;
a plurality of connection pieces coupled to the base;
a lid offset from the base, the connection pieces selectively coupled to the lid, the lid including:
a body portion, and
a plurality of side panel fasteners coupled to the body portion, each of the side panel fasteners configured to move between a locked position and an unlocked position; and
a plurality of side panels configured to couple to the base, the lid, and two of the connection pieces;
wherein the body portion includes a plurality of apertures, each of the connection piece includes a plurality of channels, and each of the side panels is configured to slide through a corresponding one of the apertures in the lid to be captured within one of the channels of a corresponding first connection piece and one of the channels of a corresponding second connection piece;
wherein in the locked position at least a portion of one of the side panel fasteners is located within the corresponding aperture and the side panel fastener is configured to prevent a corresponding one of the side panels from being removed from the corresponding aperture;
wherein in the unlocked position the side panel fastener is configured to permit the corresponding side panel to be removed from the corresponding aperture.

20. A kennel comprising:
a base;
a plurality of stepped inserts, one or more of the stepped inserts received within the base;
a plurality of connection pieces, each of the connection pieces extending between a lower end and an upper end, the lower end coupled to the base, one of the stepped inserts received within the lower end, one of the stepped inserts received within the upper end;
a lid, the upper end of each of the connection pieces coupled to the lid, one or more of the stepped inserts received within the lid; and
a plurality of side panels, each of the side panels coupled to the lid;
wherein the lid includes a plurality of apertures and the connection pieces each include a plurality of connection piece channels, wherein the side panel is configured to be received within at least one of the connection piece channels via one of the apertures.
